(19) United States
(12) Patent Application Publication
(10) Pub. No.: US 2015/0248316 A1
(43) Pub. Date: Sep. 3, 2015

(54) SYSTEM AND METHOD FOR DYNAMICALLY SELECTING BETWEEN MEMORY ERROR DETECTION AND ERROR CORRECTION

(71) Applicant: HEWLETT-PACKARD DEVELOPMENT COMPANY, L.P., Houston, TX (US)

(72) Inventors: Jeffrey C. Mogul, Palo Alto, CA (US); Naveen Muralimanohar, Palo Alto, CA (US); Mehul A. Shah, Palo Alto, CA (US); Eric A. Anderson, Palo Alto, CA (US)

(21) Appl. No.: 14/431,187

(22) PCT Filed: Sep. 28, 2012
(86) PCT No.: PCT/US2012/058056

§ 371 Date: Mar. 25, 2015

(51) Int. Cl. G06F 11/07

(52) U.S. Cl. CPC G06F 11/073; G06F 11/0763; G06F 11/0793

(57) ABSTRACT

Example methods, systems, and apparatus to dynamically select between memory error detection and memory error correction are disclosed herein. An example system includes a buffer, to store a flag settable to a first value to indicate that a memory page is to store error protection information to detect but not correct errors in the memory page. The flag is settable to a second value to indicate that the error protection information is to detect and correct errors for the memory page. The example system includes a memory controller to receive a request based on the flag to enable error detection without correction for the memory page when the flag is set to the first value, and to enable error detection and correction for the memory page when the flag is set to the second value.

### BACKGROUND

Computer memories are vulnerable to errors. For example, electrical and/or magnetic interference may cause a bit stored within a memory, such as a dynamic random access memory (DRAM), to unintentionally change states. To mitigate such memory errors, additional error protection bits may be stored within the DRAM, and a memory controller may use these additional error protection bits to detect and correct such memory errors. Different levels of error protection may be provided with the storage of these additional bits. For example, a basic form of error detection involves storing parity bits within the memory. Storing parity bits allows the memory controller to detect single-bit errors. While parity enables simple error detection of a single bit, more complex error protection may be implemented by storing additional error protection bits. For instance, error-correcting codes (ECC) stored within additional bits in memory often enable detecting and correcting errors. An example error-correcting code is a single error correction double error detection (SECDED) code.

### BRIEF DESCRIPTION OF THE DRAWINGS

FIG. 1A depicts an example computing system implemented in accordance with the teachings disclosed herein.

FIG. 1B is an example implementation of the example system of FIG. 1A.

FIG. 2 depicts example apparatus that may be used in connection with the example system of FIGS. 1A and 1B to dynamically select between memory error detection and memory error correction.

FIG. 3A is a flow diagram representative of example machine readable instructions that can be executed to implement the example apparatus of FIG. 2 to initially write to a memory page.

FIG. 3B is a flow diagram representative of a detailed implementation of the example instructions of FIG. 3A.

FIG. 4 is a flow diagram representative of example machine readable instructions that can be executed to implement the example apparatus of FIG. 2 to read from a memory page.

FIG. 5 is a flow diagram representative of example machine readable instructions that can be executed to implement the example apparatus of FIG. 2 to write to a memory page.

### DETAILED DESCRIPTION

Example methods, apparatus, and articles of manufacture disclosed herein may be used to dynamically select between enabling memory error detection without correction and enabling memory error detection and correction for memory pages. Error detection provides relatively less error protection when compared to error correction. However, error correction is more expensive than error detection in terms of energy, storage and/or processing delays. Examples disclosed herein enable different levels of protection for different portions (e.g., different memory pages) of a memory. That is, examples disclosed herein are useful to selectively provide some memory pages of a memory with error protection information that enables error detection without error correction of data stored in those memory pages, while selectively providing other memory pages with error protection information that enables error detection and error correction of data stored in those memory pages. Selectively providing some memory pages with fewer error protection bits to enable error detection without error correction and other memory pages with relatively more error protection bits to enable error detection and error correction reduces energy, storage and/or processing costs and improves overall system performance. Examples disclosed herein may also be used to switch a memory page enabled for error detection and correction to a lower level of protection involving error detection without correction, and to switch a memory page enabled for error detection without correction to a higher level of error protection involving error detection and error correction. The dynamic switching between memory error detection and memory error correction disclosed herein also reduces energy, storage, and/or processing costs and improves overall system performance.

Prior techniques to mitigate memory errors include storing additional error protection bits in memory, and configuring a memory controller to use these additional error protection bits to detect and correct such memory errors. For example, a memory chip may store nine bits comprising eight data bits and a single error protection bit. Different levels of error protection may be provided by storing fewer or more error protection bits. For example, a basic form of error detection involves storing parity bits within the memory. Parity bits allow the memory controller to detect single-bit errors. A parity bit is stored in connection with a corresponding group of n-bits (e.g., eight bits), and its value is set to a one (“1”) or a zero (“0”) depending on whether the n-bit group has an odd or even quantity of bits set to a value of “1.” During a memory transaction, if the memory controller expects to see an even number of bits with a value of “1” based on a corresponding parity bit, but instead sees an odd number of bits with the value of “1,” the memory controller detects that an error is present in the corresponding n bits. While parity allows the memory controller to detect errors in stored data, the memory controller may not correct the error because the memory controller does not know which bit contains the error based on the parity bit. Other types of error detection include cyclic redundancy check, checksum, etc.

Error protection that is relatively more robust than parity bits may be implemented by storing additional error protection bits in a memory. Error-correcting codes (ECC) may be stored within additional bits of memory to enable detecting and correcting errors. A single error correction double error detection (SECDED) code is an ECC that enables a single-bit error within a 64-bit word (eight memory chips contributing eight data bits each) to be corrected and a double-bit error (e.g., errors in two bits) within a 64-bit word to be detected. To implement this form of error correction, the SECDED code is spread across multiple chips or arrays of a memory module storing the 64-bit word (e.g., each of the eight memory chips stores a single bit of the SECDED code) so that a failure of any one memory chip will affect only one bit of the SECDED code. Some forms of error correction that use SECDED include “chipkill” and “chipkill-2.” More advanced error correcting codes may be used to correct multiple bits.

Error-correcting codes (e.g., SECDED codes) are costly in terms of energy, storage, and/or processing. For example, accessing 64 data bits in an SECDED protected memory involves retrieving 72 bits (e.g., the 64 data bits plus the eight SECDED bits) to read the 64 bits of data. To implement a single chipkill using the SECDED code, each chip can contribute only one, bit because the SECDED code can correct only a single bit out of the 72 bits. In a dynamic random access memory (DRAM) based system, an access to ECC-protected memory that uses a Hamming code (a type of EGG) activates 72 DRAM chips to retrieve a 64-byte cacheline. Activating all of these chips means reading 64 Kilobytes (kB) of data (plus 8 kB of EGG) to a row buffer for each cacheline access when using x8 DIMMs and a closed page policy. More recent implementations of chipkill employ a symbol-based Reed-Solomon code (another type of ECC) that activates 16 chips and restricts minimum cacheline size to 128 bytes. In comparison, a typical system without chipkill requires activating only 8 chips. The activation and reading of data to implement error-correcting codes (e.g., chipkill) consumes a significant amount of power, and most of the data read is often unused for any purpose other than to perform error correction. Also, the activation of a larger amount of chips (e.g., larger than a system without error correction) to support error correction may reduce parallelism within the memory. For example, in a system implementing error correction, memory chips may become temporarily unavailable to support other data accesses, which may lead to queuing delays.

Many memory systems are hardware-based and implemented so that error-correcting codes are provided for all data stored within a memory. Such systems that implement error-correcting codes for all data stored in memory use significant amounts of energy, storage, and/or processing. Unlike such prior techniques, examples disclosed herein selectively store some data in connection with error-correcting codes, while selectively storing other data in connection with relatively simpler error detection codes that do not enable error correction, thus, reducing required energy, storage, and/or processing as the simpler error detection codes require activating fewer memory chips of a memory module (e.g., memory modules having single subarray access (SSA) to retrieve an entire cacheline from a single DRAM chip of a memory module and/or multiple subarray access (MSA) capabilities to retrieve an entire cacheline from fewer than all DRAM chips of a memory module) and/or activating fewer word lines and/or bit lines within a single chip. Examples disclosed herein can use different criteria to determine which memory pages to provide with error detection and error correction bits (e.g., ECCs) and which memory pages to provide with relatively simpler error detection bits that do not provide error correction capabilities. For example, some data stored in memory may include non-recreatable content (e.g., a dirty file I/O buffer) and, thus, should be stored in memory having error protection bits that enable error detection and correction. However, other data stored in memory may be more easily recreatable (e.g., a clean file buffer that can be re-read from a data source) and, thus, may be stored in memory provided with less-costly error protection bits, such as parity, that enable error detection without error correction. Additionally, in some examples disclosed herein, memory pages storing error protection bits that enable error detection and correction may be changed to store less-costly error protection bits that enable error detection without correction, and memory pages storing less-costly error protection bits that enable error detection without correction may be changed to store error protection bits that enable error detection and error correction capabilities. Although specific types of error protection and/or error detection codes (e.g., ECC, parity) are discussed herein, any suitable types of error protection and/or error detection codes and techniques may be used with examples disclosed herein of selectively providing error detection without correction and error detection and correction capabilities. For example, any type of error correction codes may be used in the examples disclosed herein, such as a Reed-Solomon code (e.g., symbol-based protection, BCH code, etc.), a Hamming code, two tier parity (e.g., a first tier points out which chip has failed and a second tier global parity recovers the failed bits), etc. Any time of error detection codes may be used in the examples disclosed herein, such as simple parity, checksum, cyclic redundancy check (CRC), etc.

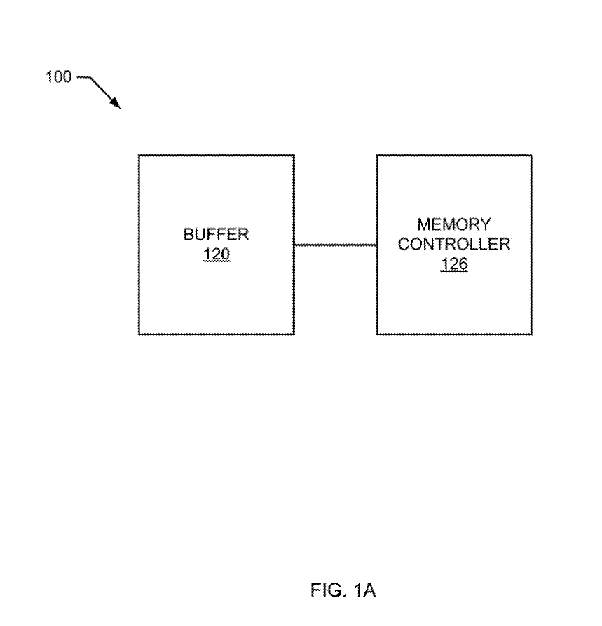

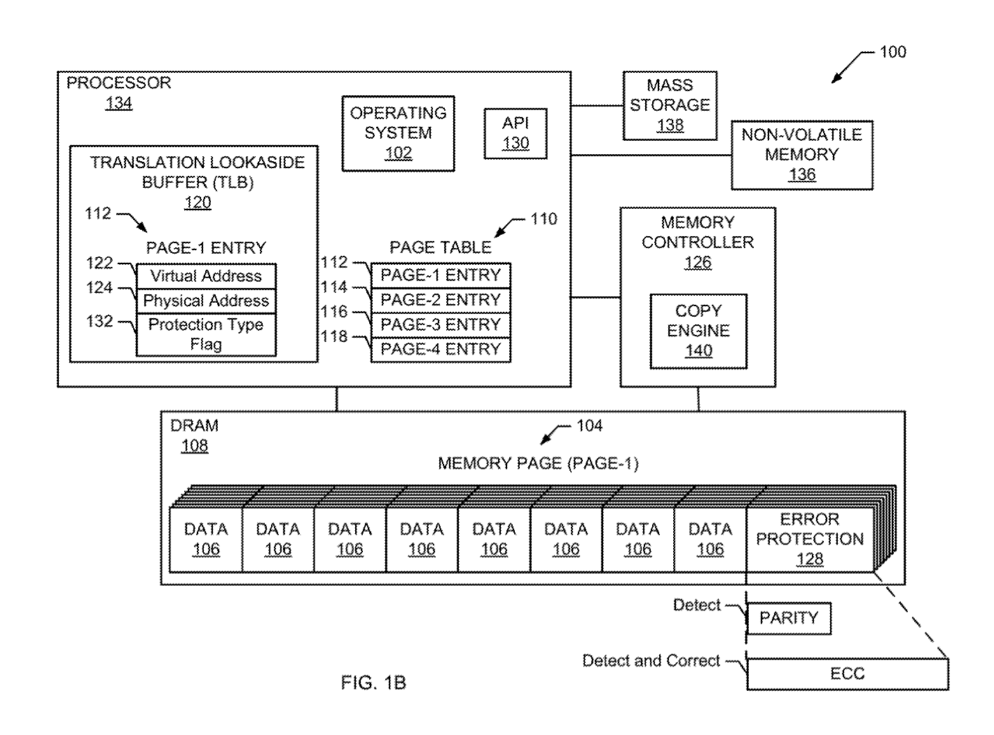

FIG. 1A illustrates an example computing system 100 that may be used to dynamically select between memory error detection and memory error correction in connection with memory pages. In the illustrated example, a buffer 120 (e.g., a translation lookaside buffer) stores a flag settable to a first value to indicate that a memory page is to store error protection information to detect but not correct errors in the memory page. The flag stored by the buffer 120 of the illustrated example is sellable to a second value to indicate that the error protection information is to detect and correct errors for the memory page. In the illustrated example, a memory controller 126 receives a request based on the flag to enable error detection without correction for the memory page when the flag is set to the first value. The memory controller 126 of the illustrated example receives the request based on the flag to enable error detection and correction for the memory page when the flag is set to the second value.

FIG. 1B is an example implementation of the example system 100 of FIG. 1A that may be used to dynamically select between implementing memory error detection and implementing memory error correction in connection with memory pages. In the illustrated example, an operating system 102 enables memory pages to be implemented with different levels of error protection (e.g., memory error detection without correction or memory error detection and correction), and enables the level of protection to be switched between error detection without correction and error detection and correction on a page-by-page basis.

In the illustrated example of FIG. 1B, the memory controller 126 is in communication with one or more dynamic random access memory (DRAM) storage devices (e.g., one or more DRAM chips). For ease of illustration, in the example of FIG. 1B, one DRAM 108 is shown. The memory controller 126 of the illustrated example is also in communication with a processor 134. The processor 134 of the illustrated example is in communication with a non-volatile memory 136 and a mass storage memory 138. The DRAM 108 of the illustrated example is used as a page memory to store recently and/or frequently accessed data. In some instances, the data in the DRAM 108 is retrieved from a data source such as the non-volatile memory 136, the mass storage memory 138, and/or any other local and/or remote data sources. In the illustrated example, the DRAM 108 stores such data in memory pages such as a memory page 104 shown in FIG. 1B. When the processor 134 performs an access to a memory address for which corresponding data is stored in the DRAM 108, the memory controller 126 causes the memory access to retrieve the requested data from a corresponding memory page (e.g., the memory page 104) in the DRAM 108.

In the illustrated example, the memory page (PAGE-1) 104 stores data 106 in a physical memory (e.g., an example DRAM 108) at a physical memory address. Virtual memory is used by the operating system 102 to perform memory allocation for a program and/or application. Pages in virtual memory map to physical pages (e.g., the memory page 104) stored at physical addresses in the DRAM 108. In the illustrated example, the example processor 134 is provided with an example page table 110 to be used by the operating system 102 to store mappings between virtual memory addresses, referred to by programs and/or applications, and physical memory addresses of physical memory (e.g., the DRAM 108). The page table 110 of the illustrated example includes mapping entries 112-118 for PAGES 14, of which memory page (PAGE-1) 104 is shown in detail in FIG. 1B. While the page table 110 of the illustrated example shows mapping entries 112-118, the page table 110 may include additional or fewer mapping entries to map virtual memory addresses to physical memory addresses. Virtual memory addresses stored in the page table 110 are used by the operating system 102 to locate corresponding physical memory addresses (e.g., a location of where data 106 is stored in the DRAM 108).

The processor 134 of the illustrated example is also provided with the translation lookaside buffer (TLB) 120 of recently-used mapping entries (e.g., the mapping entries 112-118) from the page table 110 for use by the operating system 102 to translate between virtual and physical addresses. The TLB 120 of the illustrated example caches page mappings from the page table 110 for faster access by the operating system 102. An example mapping entry 112 for the memory page 104 is illustrated in the TLB 120 of FIG. 1B. The mapping entry 112 includes a virtual address 122 and a corresponding physical address 124. When an access request is received from an application (e.g., a read or write request with a corresponding virtual address), the operating system 102 searches the TLB 120 for the requested virtual address (e.g., the virtual address 122). If the requested virtual address is found in the TLB 120 (referred to as a TLB hit), a physical address corresponding to the virtual address (e.g., the physical address 124) is used for memory access (e.g., to access PAGE-1 104). If the requested virtual address is not found in the TLB 120 (referred to as a TLB miss), the operating system 102 and/or the processor 134 of the illustrated example may search for the requested virtual address in the page table 110. If the requested virtual address is found in the page table 110, the processor 134 creates a mapping entry (e.g., similar to mapping entry 112) in the TLB 120 and performs the memory access using the corresponding physical address. A mapping entry (e.g., the mapping entry 112) in the TLB 120 of the illustrated example may also contain state information related to the page mappings such as a number of memory references, memory fetch width, etc.

In the illustrated example, the computing system 100 is provided with the memory controller 126 to manage memory accesses to the DRAM 108. To manage accesses to the DRAM 108, the memory controller 126 contains logic to read and/or write data to the DRAM 108 (e.g., data 106 in the memory page 104). Additionally, the memory controller 126 implements memory error protection for memory pages (e.g., the memory page 104) using error protection bits stored in the DRAM 108. In the illustrated example, error protection bits are shown as error protection bit(s) 128 stored in the DRAM 108 in association with those memory pages. The error protection bit(s) 128 of the illustrated example include parity bit(s) if memory error detection without error correction is to be enabled for the memory page 104. If memory error detection and correction is to be enabled for the memory page 104, the error protection bit(s) 128 store ECC. As shown in the example of FIG. 1B, parity bit(s) generally consist of a smaller amount of bits than ECC (e.g., parity utilizes only a subset of the ECC bits). Although shown in the illustrated example as ECC or parity bits, any type of error detecting or correcting codes and/or methods may be used.

To perform dynamic error protection, the operating system 102 of the illustrated example determines different levels of error protection to be implemented on a page-by-page basis. The operating system 102 of the illustrated example determines that some memory pages are to be implemented to enable error detection without correction and that some memory pages are to be implemented to enable error detection and correction. The operating system 102 may also determine what level of error detection without correction and what level of error detection and correction are to be implemented. For example, the operating system 102 may determine that a more complex method of error detection and correction (e.g., more complicated ECC) is to be implemented for particular memory pages. The operating system 102 of the illustrated example bases the level of error protection that should be provided for a memory page on whether the data in the memory page is relatively easily recreatable or whether the memory page contains non-recreatable data contents. For example, a memory page (e.g., the memory page 104) to which data changes have not been made since it was read from a data source into the DRAM 108 may be deemed easily recreatable by the operating system 102 by re-reading the memory page from the data source (e.g., the mass storage 138, the non-volatile memory 136, or any other local or remote memory). In some examples, the operating system 102 may base the level of error protection that should be provided for a memory page on the level of importance of data stared in the memory page.

If a memory page is able to be relatively easily recreated, the operating system 102 of the illustrated example determines that the memory page is to be provided with error detection codes (e.g., parity bit(s)) as the error protection information 128 to enable error detection without correction, in such examples, the memory page 104 is implemented to enable error detection without error correction because, if an error is detected, the memory page 104 may be discarded and recreated in a different physical memory region of the DRAM 108 by re-reading the memory page 104 from the data source.

In other examples, the operating system 102 determines that a memory page should be implemented with error detection and error correction. For example, a dirty file input/output (I/O) buffer (e.g., a memory page to which data changes have been made since it was read from a data source) has contents that are not easily recreatable or not recreatable at all and, as such, the operating system 102 implements a memory page for the dirty file I/O buffer to enable error detection and error correction. In addition to basing the level of error protection for a memory page on whether the data of the memory page can be easily recreated, the operating system 102 of the illustrated example may also provide an application programming interface (API) (e.g., an API 130) to allow applications and/or the operating system to mark certain memory pages as recreatable or not recreatable. For example, the API 130 may indicate that memory pages comprising Web browser caches are easily recreatable by re-retrieving the corresponding data from corresponding uniform resource locator (URL) sites and, thus, the operating system 102 would implement memory pages containing the Web browser cache to enable error detection without correction. The API 130 may be used to provide the level of importance of data within a memory page or to indicate the level of error protection to be implemented for particular memory pages.

To implement dynamic error protection, a mapping entry (e.g., the mapping entry 112) in the TLB 120 includes a protection type flag 132. When the operating system 102 of the illustrated example determines that the memory page 104 is to be provided with error protection bits 128 that enable error detection without correction, the protection type flag 132 is set in the mapping entry 112 for the memory page 104 to indicate error detection without correction. When the operating system 102 of the illustrated example determines that the memory page 104 is to be provided with error protection bits 128 that enable error detection and error correction, protection type flag 132 is set in the mapping entry 112 for the memory page 104 to indicate error detection and correction. In some examples, the protection type flag 132 of the illustrated example is a bit that is set low (e.g., “0”) to indicate error detection without correction and set high (e.g., “1”) to indicate error detection and correction. Alternatively, low (e.g., “0”) may indicate error detection and correction, and high (e.g., “1”) may indicate error detection without correction. The protection type flag 132 of the illustrated example is passed to the memory controller 126 to implement the particular type of error protection indicated thereby (e.g., error detection without correction, or error detection and correction) for each reference to a corresponding memory page (e.g., the memory page 104).

In the illustrated example, in response to instructions to write to a memory page 104 in the DRAM 108, the memory controller 126 configures the data to be written to the memory page 104 based on the protection type flag 132 by storing parity bit(s) for error detection without correction or ECC(s) for error detection and correction. For example, if the protection type flag 132 is set for error detection without correction, the memory controller 126 of the illustrated example determines and stores parity bit(s) at the error protection bit(s) 128. If the protection type flag 132 is set for error detection and correction, the memory controller 126 of the illustrated example determines and stores an ECC at the error protection bit(s) 128. In the illustrated example, in response to receiving a request to read from a memory page 104 in the DRAM 108, the memory controller 126 receives from the processor 134 the error protection type flag 132 to determine the type of error protection that is enabled for the memory page 104. For example, if data is stored in the memory page 104 with parity bit(s), the memory controller 126 of the illustrated example reads the parity bit(s) and determines if an error is present in the memory page 104 based on the parity bit(s). If data is stored with an ECC, the memory controller 126 of the illustrated example reads the ECC, determines if an error is present in the memory page 104 based on the ECC, and attempts to correct the error based on the ECC if an error is found.

In some examples, the DRAM 108 includes a row buffer to store recently read data and/or data to be written to the DRAM 108. In a traditional DRAM design, in response to a read request, the entire row buffer will be filled with data (e.g., data 106). In response to a write request, the entire row buffer will store data (e.g., data 106) to be written to the DRAM 108. In some such examples, the size of the row buffer (e.g., 8 KB) may be larger than the size of a single memory page entry (e.g., entry 112) (e.g., 4 KB). If the row buffer size is larger than the memory page entry size (e.g., larger than some threshold), the operating system 102 attempts to ensure that the entire row buffer contents involved in a read or write operation are implemented with either error detection without correction or error detection and error protection. For example, all data in a row buffer should be implemented with either parity bit(s) or ECC. To attempt to ensure that the entire row buffer contents are implemented with either error detection without correction or error detection and error correction, the operating system 102 sets the protection type flags (e.g., the protection type flag 132) to the same value for a group of adjacent memory pages (e.g., memory pages stored adjacently in the DRAM 108). For example, if a memory page in a group of adjacent memory pages is to be implemented with error detection and error correction, the operating system 102 sets the protection type flag 132 for all memory pages in the group to implement error detection and error correction. If no memory page in the group of adjacent memory pages is to be implemented with error detection and error correction, the operating system 102 sets the protection type flag 132 for all memory pages in the group to implement error detection.

The operating system 102 of the illustrated example may also change the level of error protection for a memory page between error detection without correction and error detection with correction. For example, after the memory page 104 is read from a data source and implemented to enable error detection without correction, a process may subsequently write to it via a write access and, thus, alter the data in the memory page 104. As such, the operating system 102 of the illustrated example determines that the memory page 104 is no longer easily recreatable because its data in the DRAM 108 is different from the originally read data stored in the originating data source. Because the data in the memory page 104 has changed and cannot be recreated by re-reading it from the originating data source, the operating system 102 converts the memory page 104 to enable error detection and correction. To convert levels of memory error protection for an existing memory page, the operating system 102 of the illustrated example allocates a memory page in the DRAM 108. The operating system 102 sets the protection type flag 132 in the mapping entry 112 for the new error protection level (e.g., sets the protection type flag 132 to indicate error detection and correction flag) and sends the protection type flag 132 to the memory controller 126. A memory copy engine 140 located in the memory controller 126 of the illustrated example copies the data 106 from the original memory page 104 in the DRAM 108 to the newly allocated memory page which takes the place of the original memory page 104. In the illustrated example, the copy engine 140 is located in the memory controller 126. In other examples, the copy engine 140 may be located in the processor 134 or elsewhere in the system 100. The memory controller 126 of the illustrated example then determines an ECC and stores the ECC in the error protection bit(s) 128 of the newly allocated memory page 104. The operating system 102 of the illustrated example then updates the mapping entry 112 of the old memory page to correspond to the newly allocated memory page 104. For example, the operating system 102 updates the physical address 124 to correspond to the newly allocated memory page 104 and to deallocate the original memory page.

In some cases, errors in the memory page 104 are not correctable because the protection type flag 132 indicates that the memory page 104 is enabled for error detection without correction, or because the quantity of detected errors is more than is able to be corrected using a particular ECC in the error protection bit(s) 128 when the protection type flag 132 indicates that the memory page 104 is enabled for error detection and correction. For example, when the protection type flag 132 indicates error detection without correction, parity bit(s) stored in the error protection bit(s) 128 cannot be used to correct errors and, thus, any detected errors remain uncorrected. In addition, if the memory controller 126 detects errors when the protection type flag 132 indicates error detection and correction but the number of detected errors is more than can be corrected using the ECC stored in the error protection bit(s) 128 (e.g., only a single error can be corrected when an SECDED code is stored even if two errors are detected), the detected errors remain uncorrected. When error(s) remain uncorrected, the memory controller 126 of the illustrated example notifies the operating system 102 of the uncorrected error(s) and the memory page (e.g., the memory page 104) associated with the uncorrected error(s). If the operating system 102 of the illustrated example is capable of recreating the memory page (e.g., by re-reading the memory page from an originating data source or other available data source also storing the data), the operating system 102 will recreate the memory page. If the memory page cannot be recreated, the operating system 102 of the illustrated example notifies an application (e.g., the application requesting the memory page) that an error has occurred, and removes the memory page to avoid re-encountering the same failure.

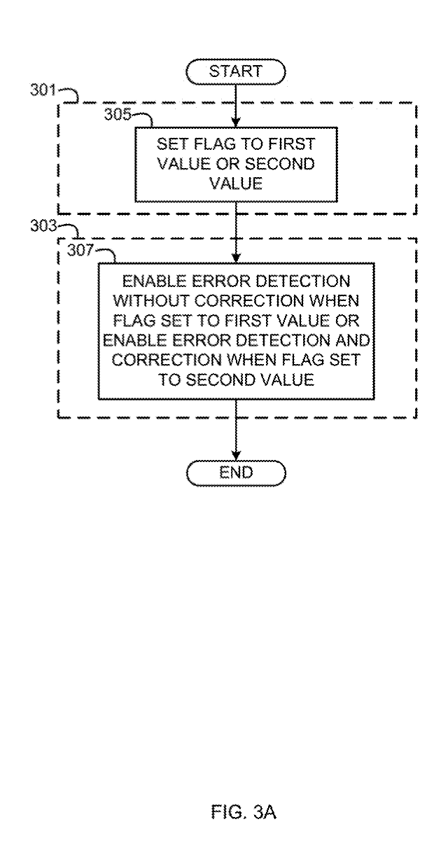

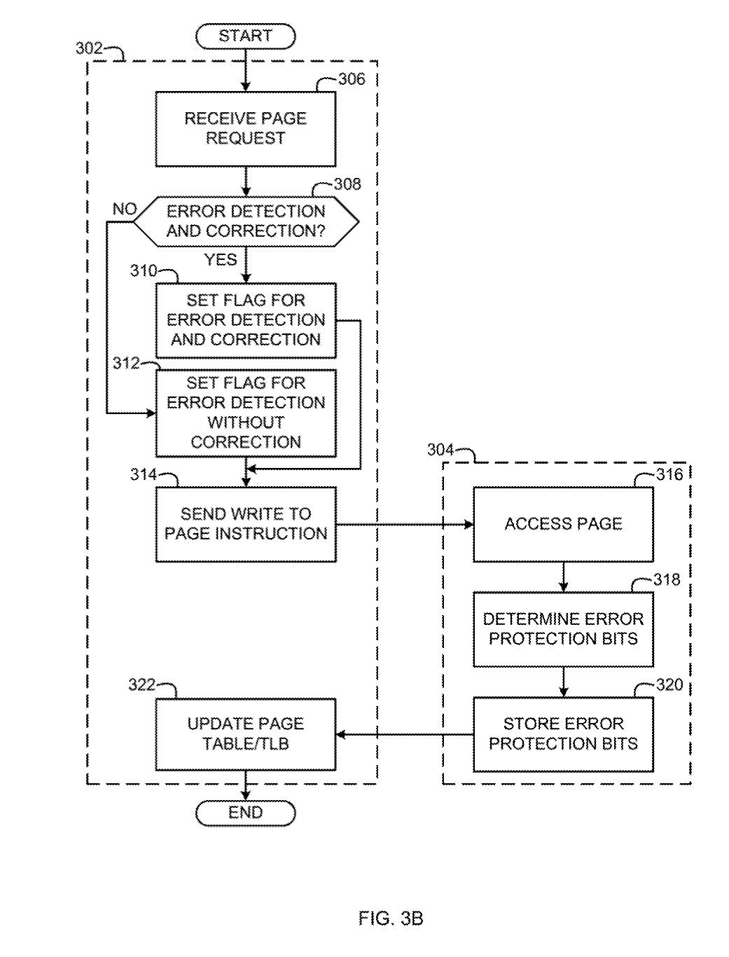

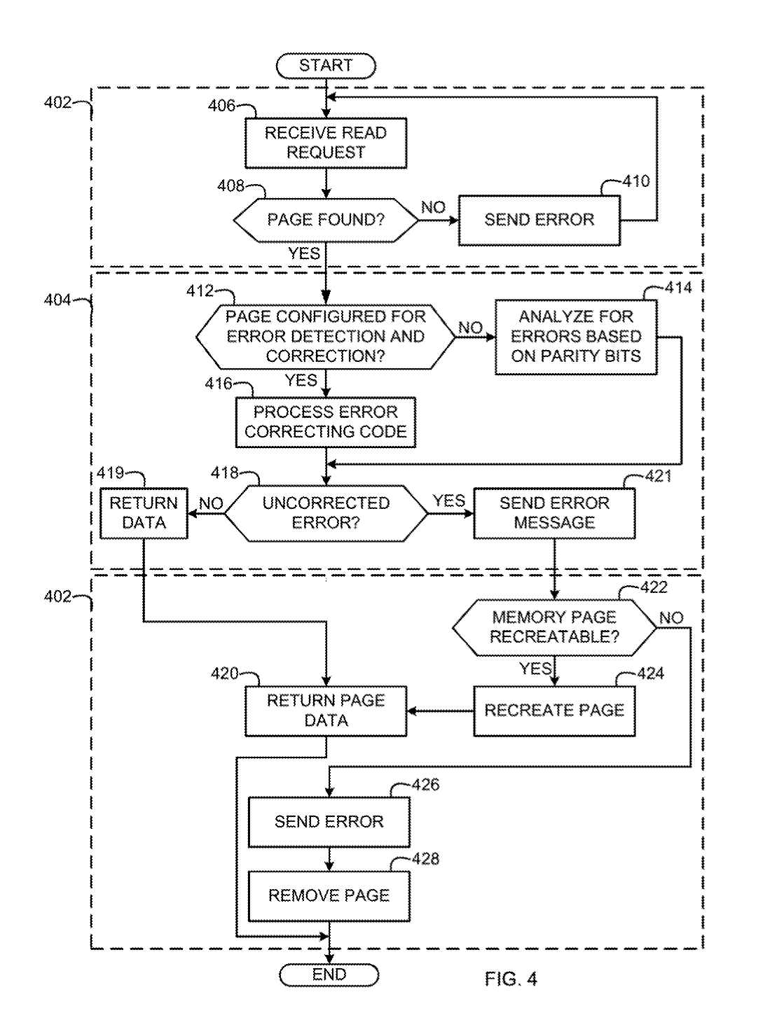

In the illustrated example, the operating system 102 is executable by the processor 134 and may be stored across one or more memories (e.g., the DRAM 108, the non-volatile memory 136, and/or the mass storage 138). The processor 134 can be implemented by one or more microprocessors or controllers from any desired family or manufacturer. In some examples, the non-volatile memory 136 stores machine readable instructions that, when executed by the processor 134, cause the processor 134 to perform examples disclosed herein. In the illustrated example, the non-volatile memory 136 may be implemented using flash memory and/or any other type of memory device. The mass storage device 138 stores software and/or data. Examples of such mass storage device 138 include floppy disk drives, hard drive disks, compact disk drives and digital versatile disk (DVD) drives. The mass storage device 138 implements a local storage device. In some examples, data read into memory pages stored in the DRAM 108 is read from the non-volatile memory 136 and/or the mass storage 138. In the illustrated examples disclosed herein, the operating system 102 deems data in a memory page (e.g., the memory page 104) of the DRAM 108 to be relatively easily recreatable if the data in the memory page is exactly the same as the data from the corresponding source non-volatile memory 136 and/or the mass storage 138. However, if the data in the memory page has changed since it was read from the source non-volatile memory 136 and/or the mass storage 138, then the operating system 102 deems the memory page to not be relatively easily recreatable because it cannot simply be re-read from the corresponding source non-volatile memory 136 and/or the mass storage 138. In some examples, coded instructions of FIGS. 3A, 3B, 4, and/or 5 may be stored in the mass storage device 138, in the DRAM 108, in the non-volatile memory 136, and/or on a removable storage medium such as a CD or DVD. In some examples, the operating system 102 may implement dynamic selection between enabling memory error detection without correction and enabling memory error detection and correction in more sophisticated memory (e.g., DRAM) designs such as single-subarray access (SSA) designs in which an entire cache line can be fetched from a single DRAM chip of a memory module or multiple-subarray access (MSA) designs in which an entire cache line can be fetched from fewer than all DRAM chips of a memory module. Implementing the operating system 102 to perform such dynamic selection in these more sophisticated memory designs helps to reduce overhead (e.g., operational or energy costs) of the more sophisticated memory designs.

Examples disclosed herein enable selection of memory error detection without correction or memory error detection and correction for different memory pages, enabling selectivity of when to implement error detection and correction capabilities on a page-by-page basis. As error detection without correction is less costly than error detection and correction in terms of energy, storage, and/or processing, examples disclosed herein enable improving system performance by selecting on a page-by-page basis when to incur the cost of enabling error detection and correction.

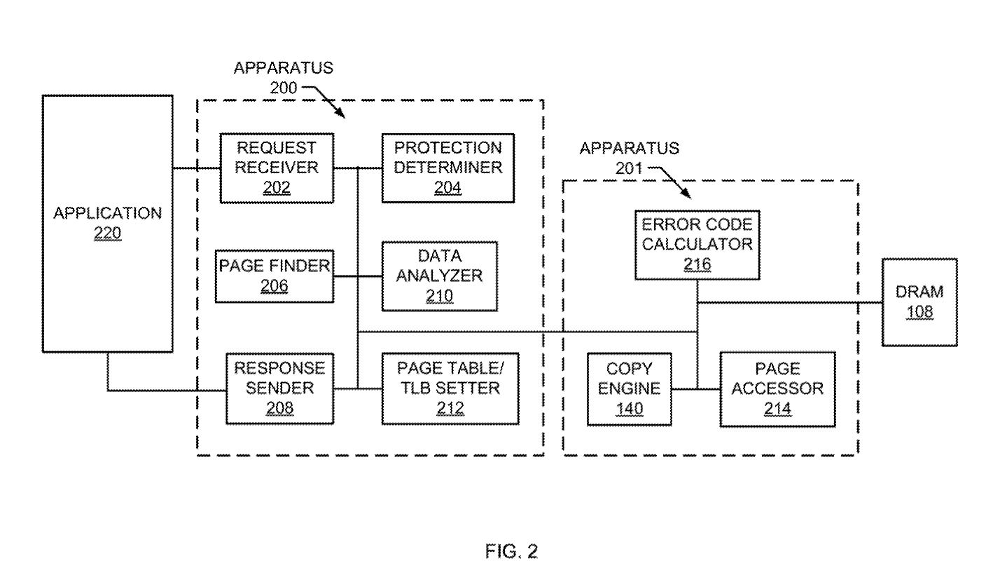

FIG. 2 depicts example apparatus 200 and 201 that may be used in connection with the example system 100 of FIGS. 1A and 1B to dynamically select between memory error detection without correction and memory error detection and correction. The apparatus 200 of the illustrated example may be implemented in the processor 134 of FIG. 1B, and the apparatus 201 of the illustrated example may be implemented in the memory controller 126 of FIG. 1B. In some examples, both of the apparatus 200 and 201 may be implemented by the same processor or integrated circuit. In the illustrated example of FIG. 2, the apparatus 200 includes a request receiver 202, a protection determiner 204, a page finder 206, a response sender 208 a data analyzer 210, and a page table/TLB setter 212. In the illustrated example of FIG. 2, the apparatus 201 includes a page accessor 214, an error code calculator 216, and the copy engine 140 (FIG. 1B).

The request receiver 202 of the illustrated example receives access requests from an application 220 executed by the processor 134 (FIG. 1B). In some examples, access requests may be additionally or alternatively received from the operating system 102 (FIG. 1B). An access request may be a request to write to a memory page (e.g., the memory page 104 of FIG. 1B) in the DRAM 108 or read from a memory page, for example. If a request is received from the application 220 that causes the operating system 102 to write to a memory page, the protection determiner 204 of the illustrated example determines if the memory page is to be implemented to enable error detection without correction or to enable error detection and correction. The protection determiner 204 of the illustrated example bases the level of error protection on whether a memory page may be easily recreated or whether a memory page contains non recreatable contents (e.g., contents that are not retrievable or recreatable from other sources). Where the memory page is given its initial contents by a read from a data source, the protection determiner 204 of the illustrated example determines that the memory page is relatively easily recreatable by re-reading its data from a corresponding data source and, as such, the protection determiner 204 will implement the memory page to enable error detection without correction. In such examples, the protection determiner 204 determines that the memory page is to be provided with error protection bit(s) (e.g., error protection bit(s) 128 of FIG. 1B) to enable error detection without correction because, upon detection of an error, the memory page may be discarded and recreated in a different physical memory region (e.g., a different region of the DRAM 108 of FIG. 1B) by re-reading the data for the memory page from its corresponding data source. In some examples, the protection determiner 204 may determine that a memory page contains non-recreatable data and, thus, is to be provided with error protection bit(s) (e.g., the error protection bit(s) 128) to enable error detection and correction.

In some examples, empty memory pages are initially allocated by the operating system 102 of FIG. 1B (e.g., during a start up phase of the operating system 102). In such examples, the protection determiner 204 determines that because the memory pages are empty, the memory pages are easily recreatable (or are empty of any data that would need to be recreated) and, thus, are to be implemented to enable error detection without correction. In some examples, an API (e.g., the API 130 of FIG. 1B) is used to provide the application 220 with control over what memory pages the protection determiner 204 will determine to be easily recreatable and, thus, what memory pages should be implemented to enable error detection without correction and which should enable error detection and correction. In some examples, the protection determiner 204 and/or the application 220 may determine what level of error detection without correction and what level of error detection and correction are to be implemented. For example, a more complex method of error detection and correction (e.g., a more complicated ECC) may be used for particular memory pages. In some examples, the protection determiner 204 and/or the application 220 may base the level of error detection and/or the level of error correction that should be provided for a memory page on the level of importance of the data stored in the memory page.

Once the protection determiner 204 of the illustrated example has determined whether a memory page should be implemented to enable error detection without correction or error detection and correction, the protection determiner 204 of the illustrated example sets a corresponding protection type flag (e.g., the protection type flag 132 of FIG. 1B) in a corresponding mapping entry (e.g., the mapping entry 112 of FIG. 1B) of a TLB (e.g., the TLB 120 of FIG. 1B) to indicate either error detection without correction or error detection and correction. The protection determiner 204 of the illustrated example then sends the apparatus 201 instructions to write to a memory page according to the protection type flag set to either error detection without correction or error detection and correction.

The page accessor 214 of the apparatus 201 of the illustrated example receives the instructions to write to the memory page 104 (FIG. 1B) according to the type of error protection indicated by the protection type flag 132 (FIG. 1B). The page accessor 214 of the illustrated example writes to the memory page at a physical address in the DRAM 108. The error code calculator 216 of the illustrated example determines values of parity bit(s) if the protection type flag 132 is set to error detection without correction and determines ECC values if the protection type flag 132 is set to error detection and correction. The page accessor 214 of the illustrated example stores the parity bit(s) or ECC at the error protection bit(s) 128 (FIG. 1B) of the memory page 104.

The page table/TLB setter 212 of the apparatus 200 of the illustrated example updates the mapping entry 112 (FIG. 1B) for the memory page 104. For example, the page table/TLB setter 212 updates the physical address 124 (FIG. 1B) of the memory page 104.

In some examples, the request receiver 202 of the illustrated example receives an access request (e.g., including a virtual memory address) from the application 220 to read from a memory page (e.g., the memory page 104 of FIG. 1B). The page finder 206 of the illustrated example searches the TLB 120 (FIG. 1B) for the requested virtual memory address (e.g., the virtual memory address 122 of FIG. 1B) associated with the requested memory page. If the page finder 206 cannot locate the requested virtual memory address in the TLB 120, the page finder 206 of the illustrated example searches the page table 110 (FIG. 1B) for the requested virtual address. If the requested virtual address is not found in either the TLB 120 or the page table 110, the response sender 208 of the illustrated example sends an error message to the application 220 indicating that the requested memory page was not found. If the page finder 206 of the illustrated example finds the requested virtual memory address associated with the requested memory page, the page finder 206 sends the corresponding physical address (e.g., the physical address 124 of FIG. 1B) and the protection type flag (e.g., the protection type flag 132 of FIG. 1B) to the apparatus 201.

The page accessor 214 of the illustrated example receives the physical address 124 from the page finder 206 and accesses the memory page 104 at the physical address 124 in the DRAM 108. The page accessor 214 of the illustrated example analyzes the received protection type flag 132 to determine if the memory page 104 is configured to enable error detection without correction or error detection and correction. If the memory page 104 is configured to enable error detection without correction, the error code calculator 216 of the illustrated example reads the parity bit(s) stored in the error protection bit(s) 128 (FIG. 1B) of the memory page 204 to analyze the memory page 104 for any errors. If the memory page 104 is configured to enable error detection and correction, the error code calculator 216 of the illustrated example reads the ECC stored in the error protection bit(s) 128 to analyze the memory page 104 for any errors. If an error is detected, the error code calculator 216 of the illustrated example attempts to correct the error using the ECC. If no errors are found and/or errors are found and corrected by the error code calculator 216 of the illustrated example, the page accessor 214 of the illustrated example returns the requested memory page data to the apparatus 200. The response sender 208 of the illustrated example receives the requested memory page data and returns the requested memory page data to the application 220 that requested the memory page.

If the error code calculator 216 of the illustrated example finds an uncorrected error, the page accessor 214 of the illustrated example informs the apparatus 200. An error may be uncorrected if an error is detected with using parity bit(s) or an error is detected, but cannot be corrected with the provided ECC. The data analyzer 210 of the illustrated example receives an indication that an uncorrected error has been found in the requested memory page 104. The data analyzer 210 of the illustrated example determines if the memory page 104 is recreatable. For example, if the memory page 104 was read in from a data source and has not been modified since reading it from the data source, the data analyzer 210 determines that the memory page 104 may be recreated. In some examples, an application (e.g., the application 220) may be used to recreate the memory page (e.g., by reading in data from the application). If the memory page may be recreated, the apparatus 200 and 201 write to a memory page as discussed above using data read in from the application. Once the memory page 104 has been recreated, the apparatus 200 and 201 perform the requested read of the memory page 104 and return the requested memory page data to the application 220. If the memory page 104 is not recreatable, the response sender 208 of the illustrated example sends an error message to the application 220 indicating that an error occurred in the memory page 104. If the memory page 104 is not recreatable, the page table/TLB setter 212 of the illustrated example removes the mapping entry 112 (FIG. 1B) corresponding to the memory page 104 to remove the memory page 104.

In some examples, the request receiver 202 of the illustrated example may receive an access request (e.g., including a virtual memory address 122) from the application 220 to write to the memory page 104 that may alter the data 106 (FIG. 1B) stored in the memory page 104. The page finder 206 of the illustrated example searches the TLB 120 (FIG. 1B) for the requested virtual memory address (e.g., the virtual memory address 122) associated with the requested memory page 104. If the page finder 206 cannot locate the requested virtual memory address in the TLB 120, the page finder 206 of the illustrated example searches the page table 110 (FIG. 1B) for the requested virtual address. If the requested virtual address is not found in either the TLB 120 or the page table 110, the response sender 208 of the illustrated example sends an error message to the application 220 indicating that the requested memory page 104 was not found. If the page finder 206 of the illustrated example finds the requested virtual memory address 122 associated with the requested memory page 104, the page finder 206 sends the corresponding physical address 124 (FIG. 1B), the protection type flag 132 (FIG. 1B), and the data 106 to be stored in the memory page 104 to the apparatus 201 to access the memory page 104.

The protection determiner 204 of the illustrated example determines when the level of error protection for the memory page 104 should be changed (e.g., implemented to enable error detection and correction instead of to enable error detection without correction or implemented to enable error detection without correction instead of to enable error detection and correction) based on whether the data 106 stored therein is recreatable. If the protection determiner 204 of the illustrated example determines that the level of error protection for the memory page 104 should be changed, the protection determiner 204 changes the protection type flag 132 (FIG. 1B) to correspond to the new level of error protection. Based on the type of error protection determined by the protection determiner 204 of the illustrated example, the error code calculator 216 of the illustrated example determines parity bit(s) or an ECC for the memory page 104 based on the protection type flag 132 and the page accessor 214 of the illustrated example stores the parity bit(s) or ECC in the error protection bit(s) 128 of the memory page 104 in the DRAM 108. The page accessor 214 of the illustrated example also writes the new data 106 to the memory page 104.

When changing the level of error protection for a memory page, the copy engine 140 of the illustrated example allocates a memory page 104 in the DRAM 108 and copies data from the old memory page to the newly allocated memory page 104. The error code calculator 216 of the illustrated example determines new parity bit(s) or a new ECC based on the protection type flag 132, and the page accessor 214 of the illustrated example stores the parity bit(s) or the ECC at the newly allocated memory page 104. The page table/TLB setter 212 of the illustrated example updates the physical address 124 (FIG. 1B) in the mapping entry 112 (FIG. 1B) associated with the memory page 104 to deallocate the old memory page.

The example apparatus 200 and 201 of FIG. 2 enable a dynamic selection between levels of error protection. Configuring memory pages to enable error detection without correction rather than error detection and correction reduces energy, storage, and/or processing costs and improves overall system performance.

While example implementations of the example apparatus 200 and 201 have been illustrated in FIG. 2, one or more of the elements, processes and/or devices illustrated in FIG. 2 may be combined, divided, re-arranged, omitted, eliminated and/or implemented in any other way. Further, the request receiver 202, the protection determiner 204, the page finder 206, the response sender 208, the data analyzer 210, the page table/TLB setter 212, the page accessor 214, the error code calculator 216, the copy engine 140, and/or, more generally, the example apparatus 200 and/or 201 of FIG. 2 may be implemented by hardware, software, firmware and/or any combination of hardware, software and/or firmware. Thus, for example, any of the request receiver 202, the protection determiner 204, the page finder 206, the response sender 208, the data analyzer 210, the page table/TLB setter 212, the page accessor 214, the error code calculator 216, the copy engine 140, and/or, more generally, the example apparatus 200 and/or 201 of FIG. 2 could be implemented by one or more circuit(s), programmable processor(s), application specific integrated circuit(s) (“ASIC(s)”), programmable logic device(s) (“PLD(s)”) and/or field programmable logic device(s) (“FPLD(s)”), etc. When any of the apparatus or system claims of this patent are read to cover a purely software and/or firmware implementation, at least one of the request receiver 202, the protection determiner 204, the page finder 206, the response sender 208, the data analyzer 210, the page table/TLB setter 212, the page accessor 214, the error code calculator 216, and/or the copy engine 140 are hereby expressly defined to include a tangible computer readable medium such as a memory, DVD, compact disc (“CD”), etc. storing the software and/or firmware. Further still, the example apparatus 200 and/or 201 of FIG. 2 may include one or more elements, processes and/or devices in addition to, or instead of, those illustrated in FIG. 2, and/or may include more than one of any or all of the illustrated elements, processes and devices.

Flowcharts representative of example machine readable instructions for implementing the example apparatus 200 and 201 of FIG. 2 are shown in FIGS. 3A, 38, 4, and 5. In these examples, the machine readable instructions comprise one or more programs for execution by one or more processors similar or identical to the processor 134 of FIG. 1B. The program(s) may be embodied in software stored on a tangible computer readable medium such as a memory associated with the processor 134, but the entire program(s) and/or parts thereof could alternatively be executed by one or more devices other than the processor 134 and/or embodied in firmware or dedicated hardware. Further, although the example program(s) is/are described with reference to the flowcharts illustrated in FIGS. 3A, 3B, 4, and 5, many other methods of implementing the example system 100 and/or the example apparatus 200 and 201 may alternatively be used. For example, the order of execution of the blocks may be changed, and/or some of the blocks described may be changed eliminated, or combined.

As mentioned above, the example processes of FIGS. 3A, 3B, 4, and/or 5 may be implemented using coded instructions (e.g., computer readable instructions) stored on a tangible computer readable medium such as a hard disk drive, a flash memory, a read-only memory (“ROM”), a cache, a random-access memory (“RAM”) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 3A, 3B, 4, and/or 5 may be implemented using coded instructions (e.g., computer readable instructions) stored on a non-transitory computer readable medium such as a hard disk drive, a flash memory, a read-only memory, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The flow diagram of FIG. 3A depicts an example process 301 performed by the apparatus 200 of FIG. 2 and an example process 303 performed by the apparatus 201 of FIG. 2 that can be used to initially write to a memory page. During the process 301, the apparatus 200 sets a flag to a first value to indicate that error detection without correction is to be used for a memory page or sets the flag to a second value to indicate that error detection and correction are to be used for the memory page (block 305). During the process 303, the apparatus 201 enables error detection without correction for the memory page when the flag associated with a request is set to the first value and enables error detection and correction for the memory page when the flag associated with a request is set to the second value (block 307). The example processes 301 and 303 of FIG. 3A then end.

FIG. 3B is a flow diagram representative of a detailed implementation of the example instructions of FIG. 3A. In the illustrated example, an example process 302 is performed by the apparatus 200 of FIG. 2 and an example process 304 is performed by the apparatus 201 of FIG. 2. To initiate the process 302, the request receiver 202 (FIG. 2) receives a request to initially write to a memory page (e.g., the memory page 104 of FIG. 1B) (block 306). In some examples, the request to initially write to a memory page (e.g., a previously unwritten memory page) may result from the application 220 (FIG. 2) requesting to access data that is not yet stored in the DRAM 108, but is stored in a data source such as one or both of the memory 136 or 138 of FIG. 1B. In other examples, the request to initially write to a memory page may be a result of a memory allocation process allocating new free memory space.

The protection determiner 204 (FIG. 2) determines if the memory page 104 is to be implemented to enable error detection and correction (block 308). The protection determiner 204 bases the level of error protection on whether the memory page 104 may be relatively easily recreated or whether the memory page 104 contains non-recreatable data. The protection determiner 204 may also base the level of error protection on the importance of the data stored in the memory page. If the memory page 104 should be implemented to enable error detection and correction (block 308), the protection determiner 204 sets the protection type flag 132 (FIG. 1B) in the mapping entry 112 (FIG. 1B) of the TLB 120 (FIG. 1B) to indicate error detection and correction (block 310). If the memory page 104 should not be implemented to enable error detection and correction (block 308), the protection determiner 204 sets the protection type flag 132 to indicate error detection without correction (block 312). The protection determiner 204 may also indicate the level of error detection without correction and/or the level of error detection and correction that are to be implemented. For example, the protection determiner 204 may indicate that a particular ECC is to be used (e.g., an ECC that is more complex than other forms of ECC). The protection determiner 204 then sends the apparatus 201 instructions to write to the memory page 104 according to the type of error protection indicated by the protection type flag 132 (block 314).

In the process 304, the page accessor 214 (FIG. 2) receives the instructions to write to the memory page 104 according to the protection type flag 132, and accesses the memory page 104 at a physical address 124 (FIG. 1B) in the DRAM 108) (block 316). The error code calculator 216 (FIG. 2) determines the error protection bit(s) 128 (block 318). For example, the error code calculator 216 determines parity bit(s) if the protection type flag 132 indicates error detection without correction, and determines an ECC if the protection type flag 132 indicates error detection and correction. The page accessor 214 (FIG. 2) stores the error protection bit(s) 128 (FIG. 1B) for the memory page 104 (block 320).

At the example process 302 of the apparatus 200, the page table/TLB setter 212 (FIG. 2) updates the mapping entry 112 (FIG. 1B) for the memory page 104 (block 322). For example, the page table/TLB setter 212 updates the physical address 124 of the memory page 104. The example processes 302 and 304 of FIG. 3B then end.

The flow diagram of FIG. 4 depicts an example process 402 performed by the apparatus 200 of FIG. 2, and an example process 404 performed by the apparatus 201 of FIG. 2 that can be used to read from a memory page. Initially at the process 402, the request receiver 202 (FIG. 2) receives an access request (e.g., including a virtual memory address 122 of FIG. 1B) from an application (e.g., the application 220 of FIG. 2) to read from the memory page 104 (FIG. 1B) (block 406). The page finder 206 (FIG. 2) searches the TLB 120 (FIG. 1B) for the requested virtual memory address 122 associated with the requested memory page 104 (block 408). If the page finder 206 (FIG. 2) cannot locate the requested virtual memory address in the TLB 120, the page finder 206 searches the page table 110 (FIG. 1B) for the requested virtual address 122. If the requested virtual address 122 is not found in either the TLB 120 or the page table 110 (block 408), the response sender 208 (FIG. 2) sends an error message to the application 220 indicating that the requested memory page 104 was not found (block 410). If the page finder 206 finds the requested virtual memory address 122 associated with the requested memory page 104, the page finder 206 sends the corresponding physical address 124 (FIG. 1B) and the corresponding protection type flag 132 (FIG. 1B) to the apparatus 201 of FIG. 2.

At the process 404, the page accessor 214 (FIG. 2) receives the physical address 124 and the protection type flag 132 and determines if the corresponding memory page 104 is configured to enable error detection and correction based on the received protection type flag 132 (block 412). If the memory page is not configured to enable error detection and correction (block 412) (e.g., the memory page is configured to enable error detection without correction), the error code calculator 216 (FIG. 2) uses parity bit(s) from the error protection bit(s) 128 (FIG. 1B) stored in the memory page 104 to analyze the memory page 104 for any errors (block 414). If the memory page is configured to enable error detection and correction (block 412), the error code calculator 216 (FIG. 2) processes the ECC from the error protection bit(s) 128 (FIG. 1B) to detect and/or correct error(s) in the memory page 104 (block 416). For example, if an error is detected using the ECC, the error code calculator 216 (FIG. 2) attempts to correct the error.

If no errors are found and/or errors are found and corrected by the error code calculator 216 (block 418), the page accessor 214 returns the requested memory page data to the response sender 208 (FIG. 2) (block 419). At the process 402, the response sender 208 returns the requested memory page data to the application 220 that requested the memory page (block 420).

If the error code calculator 216 finds an uncorrected error (block 418), the page accessor 214 sends an error message to the apparatus 200 (block 421). An error may be uncorrected if an error is detected using parity bit(s) or an error is detected, but cannot be corrected with the provided ECC. At the process 402, the data analyzer 210 (FIG. 2) receives an indication that an uncorrected error has been found in the requested memory page 104 and the data analyzer 210 determines if the memory page 104 is recreatable (block 422). For example, if the memory page 104 was read in from a data source and has not been changed since it was read from the data source, the data analyzer 210 determines that the memory page 104 may be recreated. If the memory page 104 may be recreated (block 422), the apparatus 200 and 201 recreate the memory page 104, for example, in a manner similar to that used to write to a newly allocated memory page (block 424).

Once the memory page 104 has been recreated (block 424), the apparatus 200 and 201 perform the requested read from the memory page and return the requested memory page data to the application 220 (block 420). If the memory page 104 is not recreatable (block 422), the response sender 208 (FIG. 2) sends an error message to the application 220 indicating that an error occurred in the memory page 104 (block 426). When the memory page 104 is not recreatable, the page table/TLB setter 212 (FIG. 2) removes the mapping entry 112 (FIG. 1B) for the memory page 104 to remove the memory page 104. The processes 402 and 404 of FIG. 4 then end.

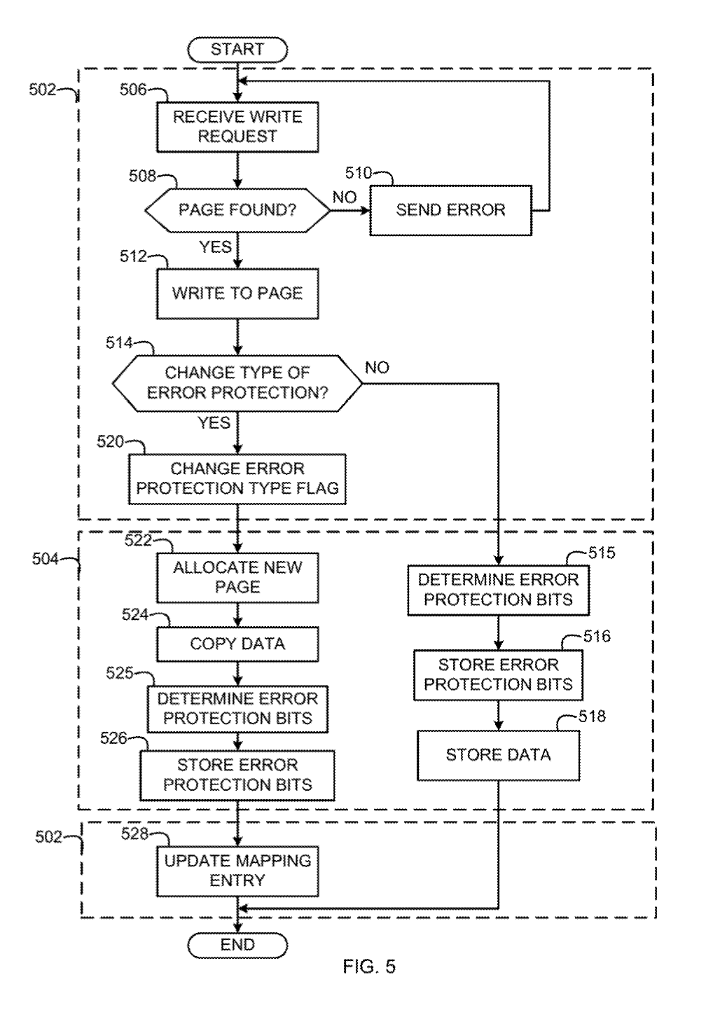

The flow diagram of FIG. 5 depicts an example process 502 performed by the apparatus 200 of FIG. 2, and an example process 504 performed by the apparatus 201 of FIG. 2 that can be used to write to a memory page. To initiate the process 502, the request receiver 202 (FIG. 2) receives an access request (e.g., including a virtual memory address 122 of FIG. 1B) from the application 220 (FIG. 2) to write to the memory page 104 (FIG. 1B) (block 506). The page finder 206 (FIG. 2) searches the TLB 120 (FIG. 1B) for the requested virtual memory address 122 associated with the requested memory page 104. If the page finder 206 cannot locate the requested virtual memory address 122 in the TLB 120, the page finder 206 searches the page table 110 (FIG. 1B) for the requested virtual address 122. If the requested virtual address 122 is not found In either the TLB 120 or the page table 110 (block 508), the response sender 208 (FIG. 2) sends an error message to the application 220 indicating that the requested memory page 104 was not found (block 510). If the page finder 206 finds the requested virtual memory address 122 associated with the requested memory page 104, the page finder 206 sends the corresponding physical address 124 (FIG. 1B) and the protection type flag 132 of FIG. 1B) to the apparatus 201 of FIG. 2 to write to the memory page 104 at the physical address 124 in the DRAM 108 (block 512).

The protection determiner 204 (FIG. 2) determines if the type of or level of error protection for the memory page 104 should be changed (block 514). In the illustrated example, the protection determiner 204 (FIG. 2) changes the type of error protection for the memory page 104 if the memory page 104 contains data that is not recreatable and the current error protection is set to error detection without correction, or if the data of the memory page 104 is recreatable and the current error protection is error detection and correction. The protection determiner 204 may also determine if the type of or level of error protection for the memory page 104 should be changed based on the importance of the data stored in the memory page 104. The protection determiner 204 may also determine that the level of error detection without correction and/or the level of error detection and correction are to be changed. For example, the protection determiner 204 may determine that a more complex ECC is to be used (e.g., rather than a less complex ECC). If the protection determiner 204 of the illustrated example determines that the level of protection for the memory page 104 should not be changed (block 514), the error code calculator 216 (FIG. 2) determines error protection bits 128 (FIG. 1B) (e.g., parity bit(s) or ECC) (block 515) for the existing data 106 and new data to be written to the memory page 104 based on the protection type flag 132. The page accessor 214 (FIG. 2) stores the error protection bit(s) 128 in the memory page 104 in the DRAM 108 (block 516). The page accessor 214 also writes the new data to the memory page 104 (block 518).

If the protection determiner 204 determines that the level of error protection for the memory page 104 should be changed (block 514), the protection determiner 204 changes the protection type flag 132 to correspond to the new level of error protection (block 520). The copy engine 140 allocates a memory page in the DRAM 108 (block 522), and copies the memory page data from the memory page 104 to the newly allocated memory page (block 524). The error code calculator 216 calculates the error protection bits 128 (e.g., parity bit(s) or an ECC) (block 525) for existing data 106 and new data to be written to the memory page 104 based on the protection type flag 132. The page accessor 214 stores the error protection bit(s) 128 in the newly allocated memory page (block 526). The page table/TLB setter 212 updates the physical address 124 in the mapping entry 112 (FIG. 1) associated with the newly allocated memory page 104 to deallocate the old memory page (block 528). The example processes 502 and 504 of FIG. 5 then end.

Although the above discloses example methods, apparatus, and articles of manufacture including, among other components, software executed on hardware, it should be noted that such methods, apparatus, and articles of manufacture are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the above describes example methods, apparatus, and articles of manufacture, the examples provided are not the only way to implement such methods, apparatus, and articles of manufacture.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed:

1. A system to dynamically select between memory error detection and memory error correction, comprising:
a buffer to store a flag settable to a first value to indicate that a memory page is to store error protection information to detect but not correct errors in the memory page and settable to a second value to indicate that the error protection information is to detect and correct errors for the memory page; and
a memory controller to receive a request based on the flag to enable error detection without correction for the memory page when the flag is set to the first value, and to enable error detection and correction for the memory page when the flag is set to the second value.

2. The system of claim 1, wherein the buffer a translation lookaside buffer.

3. The system of claim 1, wherein the request is at least one of a request to read from the memory page or a request to write to the memory page, the request received from an application.

4. The system of claim 1, wherein the memory controller is to implement at least one of parity bits, cyclic redundancy check, or checksum as the error protection information to enable error detection without correction, and is to store an error-correcting code as the error protection information to enable error detection and correction.

5. The system of claim 1, further comprising a protection determiner to determine when to enable error detection without correction for the memory page, and when to enable error detection and correction for the memory page.

6. The system of claim 5, wherein the protection determiner is to determine when to enable error detection without correction, and when to enable error detection and correction for the memory page based on whether the memory page is recreatable.

7. The system of claim 6, wherein the memory page is recreatable when data of the memory page can be read from a data source.

8. The system of claim 1, further comprising a response sender to send the memory page to an application.

9. An apparatus to dynamically select between memory error detection and memory error correction, comprising:
a page table to indicate that error detection without correction is to be used for a first memory page, and that error detection and correction are to be used for a second memory page;
a protection determiner to determine that error detection without correction is to be used for the first memory page when the first memory page is recreatable, and to determine that error detection and correction is to be used for the second memory page when the second memory page is not recreatable.

10. The apparatus of claim 9, wherein the page table has a flag bit settable to a first value to indicate that error detection without correction is to be used for the first memory page, and settable to a second value to indicate that error detection and correction are to be used for the second memory page.

11. The apparatus of claim 10, wherein the protection determiner is to send request to a memory controller based on the flag bit.

12. The apparatus of claim 11, wherein the request is at least one of a request to read from the first or second memory page or a request to write to the first or second memory page.

13. The apparatus of claim 9, wherein the protection determiner is to determine whether to change a type of error protection of the first memory page to detect and correct errors, and whether to change a type of error protection of the second memory page to detect without correcting errors.

14. A method to dynamically select between memory error detection and memory error correction, comprising:
setting a flag to a first value to indicate that error detection without correction is to be used for a memory page and to a second value to indicate that error detection and correction are to be used for the memory page;
enabling error detection without correction for the memory page when the flag associated with a request is set to the first value; and
enabling error detection and correction for the memory page when the flag associated with the request is set to the second value.

15. The method of claim 14, further comprising:
determining when to configure a memory page for use with error detection without correction and when to configure the memory page for use with error detection and correction based on whether the memory page is recreatable, the memory page being recreatable when data stored in the memory page can be read from a data source that is separate from the memory page.
